(19) United States
(12) Patent Application Publication
(10) Pub. No.: US 2007/0106617 A1
(43) Pub. Date: May 10, 2007

(54) Legal compliance system for the sale of regulated products or services

(76) Inventors: Paul Mabray, Napa, CA (US); Patrick Angeles, Napa, CA (US); Kenneth J. Rochford, Cloverdale, CA (US); Brendan Colthurst, New York, NY (US)

Correspondence Address: THE ECLIPSE GROUP, 10605 BALBOA BLVD., SUITE 300, GRANADA HILLS, CA, 91344, US

(21) Appl. No.: 11/508,747

(22) Filed: Aug. 21, 2006

Related U.S. Application Data
(60) Provisional application No. 60/734,907, filed on Nov. 8, 2005.

(51) Int. Cl. G06Q 99/00

(52) U.S. Cl. 705/59

(57) ABSTRACT

Legal compliance system for facilitating the sale of regulated products and services. System may include an input module configured to receive licensing data including a shipping address. System may include a processing module configured to access official licensing data, to determine from the official licensing data whether the received licensing data is valid, to obtain address information associated with the official licensing data, and to determine whether the obtained address information includes the shipping address associated with the received licensing data. System may further include the facilitating of transactions in accordance with the regulations governing the trade of the product or service in the governing jurisdiction. Facilitation of such transactions may include coordinating the sale between licensed entities that may be located at different tiers of a legal distribution channel, creating documentation to record the sale, and/or facilitating the distribution of funds to pay for the sale.

### RELATED APPLICATIONS

This application claims priority to U.S. Provisional Patent Application Ser. No. 60/734,907, filed Nov. 8, 2005, titled LEGAL COMPLIANCE SYSTEM FOR THE SALE OF REGULATED PRODUCTS AND/OR SERVICES; which application is incorporated in its entirety by reference in this application.

### BACKGROUND OF THE INVENTION

1. Field of the Invention

The invention relates to a system and method for facilitating the distribution and sales of regulated products or services.

2. Related Art

Regulated product and services industries in the United States face a myriad of challenges, including, but not limited to, legal, political, cultural and economic issues exacerbated by geopolitical complexities. Instead of, or often times in addition to, a body of federal laws and regulations governing the distribution of regulated products including but not limited to alcoholic beverages, each state has its own laws and regulations. To comply with the laws and regulations of each state makes distributing regulated products across the country challenging. Diversity in state laws has obstructed streamlining of the supply chain of regulated products from producers to retailers across the United States. Thus, the distribution of such regulated products remains a tedious and cumbersome task.

Every state has authority over the sale of certain regulated products, such as alcoholic beverages, within its borders. With respect to alcoholic beverages, many state laws still reflect post-prohibition era policies that purposefully hinder the distribution of alcoholic beverages. In particular, most states regulate the distribution of certain classes of regulated products pursuant to a complex and restrictive “three tier” distribution system forming the legal distribution channel that controls trade of such regulated products on a state-by-state basis. FIG. 1 is a flow diagram illustrating the conventional legal distribution channel 100 for alcoholic beverages, typically including three tiers of required licensing. As illustrated in FIG. 1, each tier in the three tier distribution system represents a licensing requirement governing the trade from one tier in the legal distribution channel 100 to another such tier until the regulated product is sold to the end consumer. A first tier 102 of producer licenses is required for trade between a producer (“P”) 104 of regulated products and a wholesaler (“W”) 106. The producer 104 is licensed by a state to manufacture regulated products and sell them to wholesalers 106. State taxes are generally paid on the regulated products by the producer 104. A second tier 108 of wholesaler licenses is required for trade between the wholesaler 106 and a retailer (“R”) 110. As an example, the retailer 110 may be a restaurant. The wholesaler 106 is licensed to resell regulated products to retailers 110 in a licensing state. A third tier of retailer licenses 112 is required for trade between the retailer 110 and an end consumer (not shown). The retailer 110 is licensed to resell regulated products to such end consumers (not shown) in a licensing state. Laws and regulations in each state dictate how each tier transaction must be processed for trade within that state. FIG. 1 also illustrates an optional fourth licensing tier 114, which may be applicable when an out-of-state shipper 116 (“OOSS”) is involved in a regulated product sales transaction. A producer 104 may itself also be a licensed out-of-state shipper 116, if permitted by a licensing state.

Consolidation of wholesaler licenses at the second tier 108 in the alcoholic beverage industry has compounded the regulatory difficulties for that industry by narrowing the legal distribution channel 100 before reaching the third tier 112 of retailer licenses to the retailers 110. The number of licensed alcoholic product wholesalers 106 has decreased from around 2,500 twenty years ago to around 250 today. This reduction means that there are effectively fewer and fewer licensed wholesalers 106 available to handle an increasing volume of brand labels from producers 104 in an evolving and growing market. Over the same time period for example, the number of wineries in the United States has tripled. This growth of the number of producers 104 of wine is not expected to slow. Concurrently, wine production and consumption continue to grow, and show little sign of slowing. As a result, producers 104 of wine have sometimes been unable to find wholesalers 106 in states where they need representation to sell wine through the second tier 108 of wholesaler licenses to retailers 110. Ultimately, there is an ever increasing volume of wine vying for access to licensed wholesalers 106 to fulfill an ever-increasing end consumer demand. Unfortunately, the three tier legal distribution channel 100 through which wine must be distributed is becoming steadily narrower. While the above problems are described in connection with the distribution of wine, similar problems exist with the distribution of other regulated products, including other types of alcoholic beverages.

Successful challenges have been made to some of the state laws that prohibit wineries from directly shipping wine to end consumers in the United States. The U.S. Supreme Court's May 2005 decision in Granholm v. Heald, 544 U.S. 460 (2005), has triggered some reductions in the obstructions to such direct shipments by producers 104 to individual end consumers. However, no solution has yet been offered to effectively address the steadily narrowing second tier 108 of wholesaler licenses to wholesalers 106 in the legal distribution channel 100, and to other barriers to free trade created by the states' “three tier” legal distribution channel 100. The Supreme Court's decision has also worsened matters in that some states have tightened their control over the distribution of wines within their borders in response to the Granholm decision.

Accordingly, a hostile sales environment currently exists for certain regulated products including wine and other alcoholic beverages. Wineries, as an example, want access to new markets to satisfy end consumer demand for their regulated products. However, these wineries may be prevented from entering those markets by state laws that constrain wineries to distribute wine using the state-by-state-licensed legal distribution channel 100. The existing legal distribution channel 100 may not, as an example, be able to accommodate the dramatic increase in the volume of producer brand labels at the second tier 108 of wholesaler licenses. Wineries are therefore being forced to provide sales and marketing services traditionally provided by licensed wholesalers 106. The most successful wineries are often those that proactively market themselves to end consumers and that take expensive and inefficient steps to themselves widen the legal distribution channel 100.

A continuing need therefore exists for a system capable of assisting producers of regulated products, including, but not limited to, alcoholic beverages, with processing and fulfilling orders placed in compliance with the state-by-state legal distribution channel 100. Further, there is a continuing need for such a system that can perform legal compliance functions traditionally performed by a licensed wholesaler 106 to allow producers 104, such as wineries and others, to meet state legal regulatory requirements necessary to ship regulated products directly to licensed retailers 110.

### SUMMARY

In an example of an implementation, a legal compliance system is provided for facilitating the sale of regulated products and services. This system includes an input module configured to receive licensing data including a shipping address. This system further includes a processing module configured to access official licensing data, to determine from the official licensing data whether the received licensing data is valid, to obtain address information associated with the official licensing data, and to determine whether the obtained address information includes the shipping address associated with the received licensing data.

In another implementation example, a computer readable medium is provided, having a plurality of instructions for facilitating legal compliance in the sale of regulated products and services. The plurality of instructions of this computer readable medium include logic configured to receive licensing data including a shipping address, logic configured to access official licensing data and to determine from the official licensing data whether the received licensing data is valid, logic configured to obtain address information associated with the official licensing data, and logic configured to determine whether the obtained address information includes the shipping address associated with the received licensing data.

As a further example of an implementation, a signal-bearing medium is provided having software for facilitating legal compliance in the sale of regulated products and services. This signal-bearing medium includes logic configured to obtain licensing data including a shipping address, logic configured to obtain official licensing data, logic configured to determine from the official licensing data whether the received licensing data is valid, logic configured to obtain address information associated with the official licensing data, and logic configured to determine whether the obtained address information includes the shipping address associated with the received licensing data.

In another implementation example, a legal compliance system is provided for facilitating the sale of regulated products. This system includes a database of official regulated products wholesaler licensing data. This system further includes a processing module configured to receive trade customer licensing data, to validate the trade customer licensing data against official regulated products wholesaler licensing data, and to receive facilitate wholesaler approval of a sale of regulated products to a trade customer.

As an additional example of an implementation, a legal compliance processing module is provided, including means for integrally accessing official regulated products resale licensing data of resale licensees in a plurality of licensing jurisdictions, and means for validating a resale licensee's regulated products resale licensing data against the official licensing data.

The legal compliance systems may further include the facilitating of transactions in accordance with the regulations governing the trade of the product or service in the governing jurisdiction. The facilitation of such transactions may include coordinating the sale between licensed entities that may be located at different tiers of the legal distribution channel, creating documentation to record the sale, and/or facilitating the distribution of funds to pay for the sale.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a flow diagram illustrating the conventional legal distribution channel for regulated products, including three tiers of required licensing.

FIG. 2 is a flow diagram illustrating one example of one implementation of a compliance system.

FIG. 3 is a flow diagram illustrating one example of one implementation of a license verification function of the compliance system.

FIG. 4 is a flow diagram illustrating one example of one implementation of a funds disbursement messaging function of the compliance system.

FIG. 5 is a flow diagram illustrating one example of one implementation of a documentation function of the compliance system.

FIG. 6 is a flow diagram illustrating one example of one implementation of a process of loading customer data into a central database as part of the compliance system.

FIG. 7 is a flow diagram illustrating one example of one implementation of a process for handling financial transactions as part of the compliance system.

FIG. 8a is a flow diagram illustrating one example of one implementation of a compliance system that may be capable of facilitating the fulfillment of a wholesale purchase order submitted by a retailer via a regulated product producer.

FIG. 8b is a continuation of the flow diagram illustrated in FIG. 8a.

FIG. 9 illustrates one example of one implementation of an initiation process that may be utilized to implement the compliance system.

FIG. 10 illustrates one example of one implementation of an order flow during operation of the compliance system.

FIG. 11 illustrates one example of one implementation of an order flow during operation of the compliance system where a wholesaler and optionally an OOSS may be notified of the order prior to completion of the sales transaction.

FIG. 12 illustrates one example of one implementation of a transaction detail function during operation of the compliance system.

FIG. 13 illustrates one example of one implementation of a funds disbursement messaging function during the operation of the compliance system.

FIG. 14 illustrates one example of one implementation of a documentation preparation function during the operation of the compliance system.

### DETAILED DESCRIPTION

The sales of certain products and services are regulated by way of license requirements that may include multiple licensing tiers. These license requirements may permit only specially licensed entities to distribute or purchase certain regulated products and/or services to or from designated types of other parties.

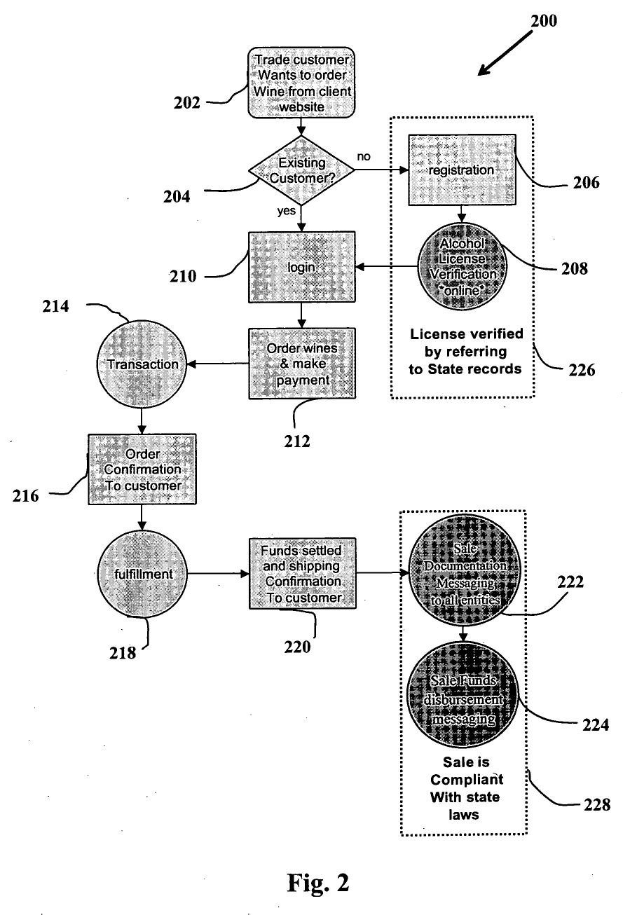

As illustrated in FIGS. 2-14, a compliance system is provided that enables producers of products and services that are regulated by way of licensing requirements to market and sell such products and services in compliance with applicable laws and regulations. The compliance system further enables the sale of products and services that are regulated differently within different jurisdictions to be marketed and sold in compliance with the laws and licensing requirements for each jurisdiction. The compliance system allows producers of products and providers of services to interface with licensees in each geographical region of a legal distribution channel, i.e., governing jurisdiction, to verify the existence of the required licenses to complete a sales transaction within the geographic region. The compliance system may also facilitate processing of payments and/or create documentation to support the completion of the sales transaction in accordance with the laws and regulations of the governing jurisdiction.

A compliance system implemented in connection with the sale of products or services through a legal distribution channel requiring licenses may, for example, provide for (i) automated verification that a customer is licensed to purchase a given product or service and/or (ii) automated facilitating of transactions in accordance with the regulations governing the trade of the product or service in the governing jurisdiction. Automated verification may include referencing official information that details those customers that are authorized to buy the product or service from a seller, such as a producer or wholesaler, as well as maintaining the integrity of that official information to ensure that such information is correct and updated. The handling of the transactions in accordance with the laws and regulations governing trade of a given product or service may, as an example, also involve (i) providing appropriate information concerning a product or service registration that is required for the sale of the product or service, (ii) coordinating the sale between licensed entities that may be located at different tiers of the legal distribution channel, (iii) creating documentation to record the sale, and/or (iv) messaging the distribution of funds to pay for the sale.

Certain aspects of the compliance system as discussed in this specification and shown in the drawings are directed to the sales and distribution of wine and other alcoholic beverages. Although this detailed description discusses and the drawings show aspects of the utilization of the compliance system in connection with the sales and distribution of wine and other alcoholic beverages, those skilled in the art will recognize that the compliance system described and shown in this application may be modified for utilization with the sale of any regulated products or services, including but not limited to alcoholic beverages, and/or services that are regulated and require compliance with licensing laws and regulations, including such laws and regulations that vary from jurisdiction-to-jurisdiction or from state-to-state.

1. System Overview

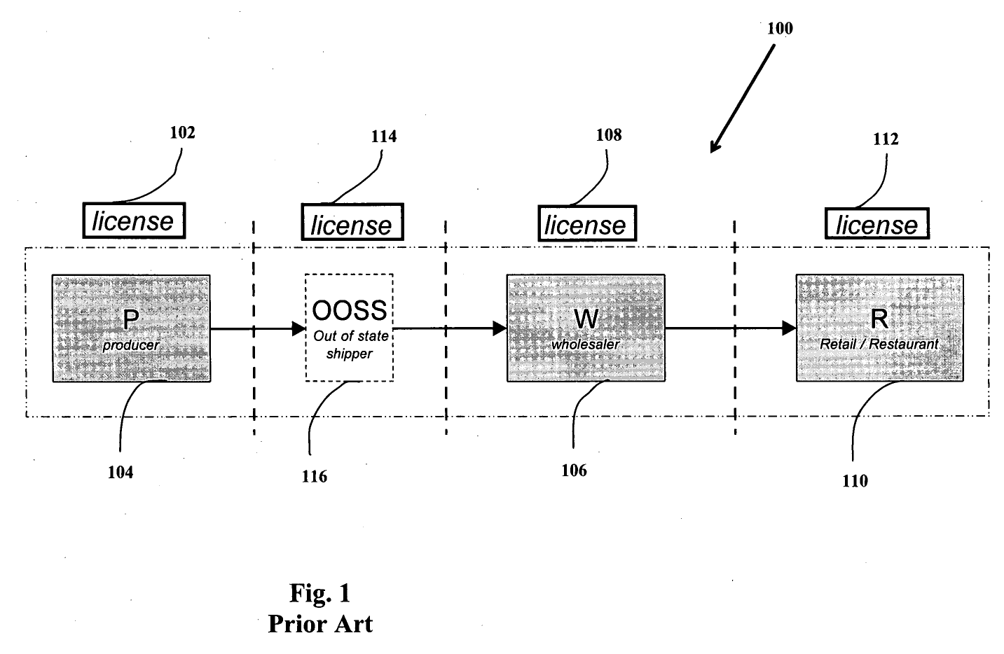

FIG. 2 is a flow diagram illustrating one example of one implementation of a compliance system 200, utilized, for example, in connection with the sale and distribution of wine. At 202, a retailer 110 (FIG. 1) desires to order wine from a producer 104, utilizing the producer's client website, for example. At 204, the compliance system 200 determines whether or not the retailer 110 is an existing customer. If not, then at 206, the retailer 110 may be directed to an input module, such as a registration screen, for example, on the website. At 208, the licensed status of the retailer 110 may be verified by referring to official state licensing data records. As an example, the records may include wine resale licensing data. In further implementations, the data may relate to other alcoholic beverages or to other regulated products. A processing module may be utilized at 208 in carrying out the verification. Alternatively, the license of the retailer 110 may be manually verified.

Once the license of the retailer 110 is verified, the retailer 110 may be directed to login at 210 as a retail customer. If no license verification is necessary because the retailer 110 is an existing customer, then the retailer may be immediately directed to login at 210. At 212, the retailer 110 may place an order for wines and make online arrangements for payment. Next, at 214, transaction details may be processed, followed by transmission of an order confirmation to the retailer 110 at 216. At 218, the order may be fulfilled, and at 220 the finds for payment may be settled and a shipping confirmation may be sent to the retailer 110. Subsequently at 222, messaging regarding appropriate documentation of the sale may be sent to all entities involved in the transaction, and at 224 messaging regarding disbursement of the funds from the sale may be sent to such entities.

Registration at 206 and licensing data verification at 208 may collectively serve to verify the trade customer's license for resale of wine, as indicated at 226. Generation of messaging regarding sale documentation to all entities involved in the transaction at 222 and messaging regarding disbursement of sale funds at 224 may collectively ensure that the sale is compliant with state laws, as indicated at 228. Hence, the compliance system 200 may facilitate the sale transaction, while maintaining compliance with state laws. As an alternative example, the customer may be another purchaser such as a retailer 110, a wholesaler 106 (FIG. 1) or an end consumer.

As illustrated in FIG. 2 and as will be further explained below, the compliance system 200 may allow a retailer 110 to place an order directly with a winery producer 104, by-passing the placement of the order directly with a wholesaler. In this manner, the compliance system 200 may assist a retailer 110 in completing an order directly with a producer 104, while still allowing the retailer to order through the required legal distribution channels 100 shown in FIG. 1. For example, the compliance system 200 may enable a retailer 110 to place an order online at the web site of a winery producer 104. The compliance system 200 may then allow the alcoholic beverage products of the winery producer 104, including wine, to be sold through the states' “three tier” legal distribution channel 100, or other legal distribution channels, without requiring resources of a wholesaler 106 as typically used in the legal distribution channel 100. The compliance system 200 may thus allow wine to be sold in compliance with a state's licensing laws and regulations without requiring the regulated products to pass through the physical custody of a wholesaler 106 or without the order being placed directly with a wholesaler 106.

It is understood by those skilled in the art that the compliance system 200 as an example may be utilized in legal distribution channels other than the “three tier” legal distribution channel 100. In implementation, the compliance system 200 may be utilized in a legal distribution channel within another country or jurisdiction within a country, or among a plurality of countries. Although much of the discussion in the application relates to the “three tier” legal distribution channel 100, it is understood that any of the compliance systems disclosed may be utilized with such other legal distribution channels.

While some involvement of a wholesaler 106 may still be necessary for order fulfillment, the compliance system 200 may automate the wholesaler involvement and automatically perform the functions necessary to be performed by the wholesaler 106 to accommodate state laws for the buying of the product by the trade customer. Rather than requiring a wholesaler 106 to buy, store and resell the regulated products, the compliance system 200 may for example allow for a regulated product to directly enter the legal distribution channel 100 after an order has been placed and paid for by the purchasing retailer 110. By performing work typically performed by the wholesaler 106, the compliance system 200 may allow winery producers 104 to work more directly within the legal distribution channel 100 and to sell regulated products in wholesaler license jurisdictions of the second tier 108 lacking broad distribution channels of wholesalers 106. The compliance system 200 may thus reduce the workload of the wholesalers 106. The compliance system 200 may also enable wholesalers 106 to more efficiently meet their legal obligations as licensees of the second tier 108. The compliance system 200 may as a result enable winery producers 104 to facilitate sales of regulated products to retailers 110 in previously closed jurisdictions of the legal distribution channel 100.

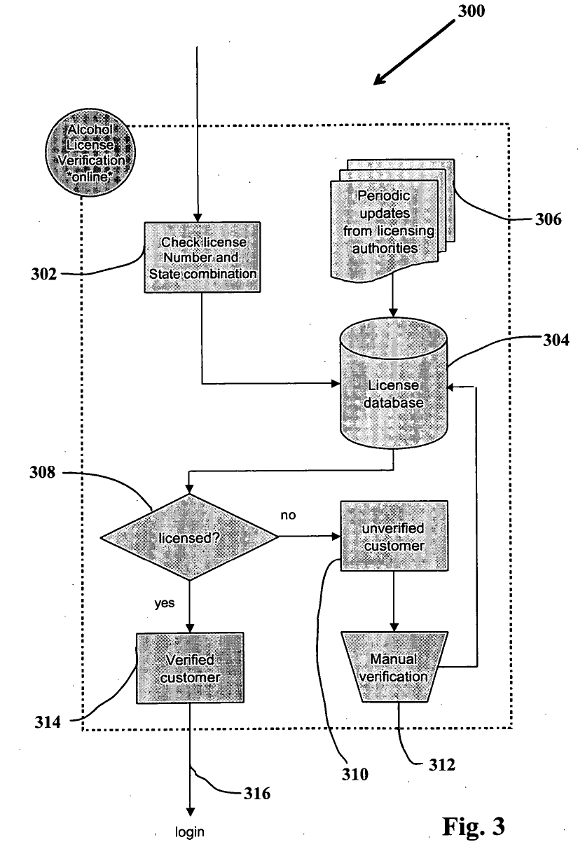

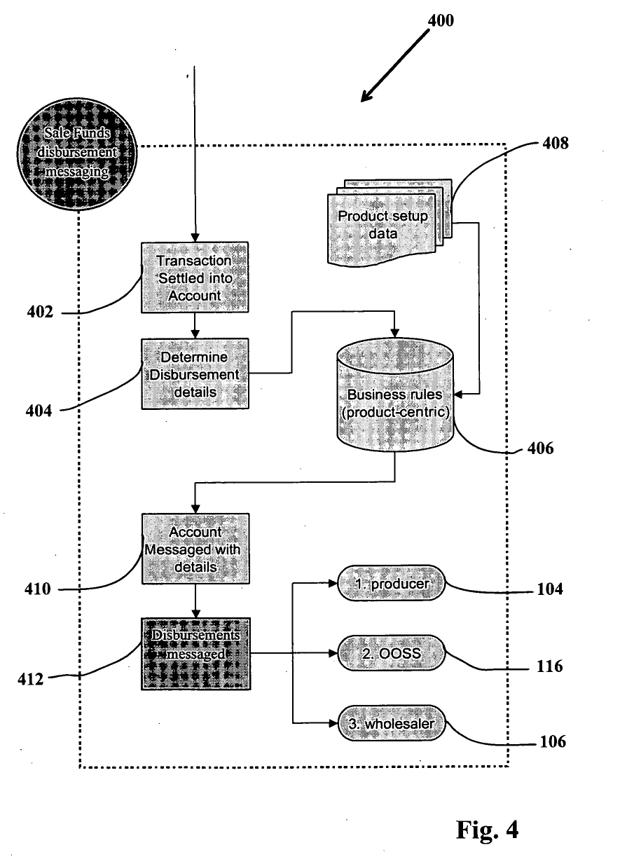

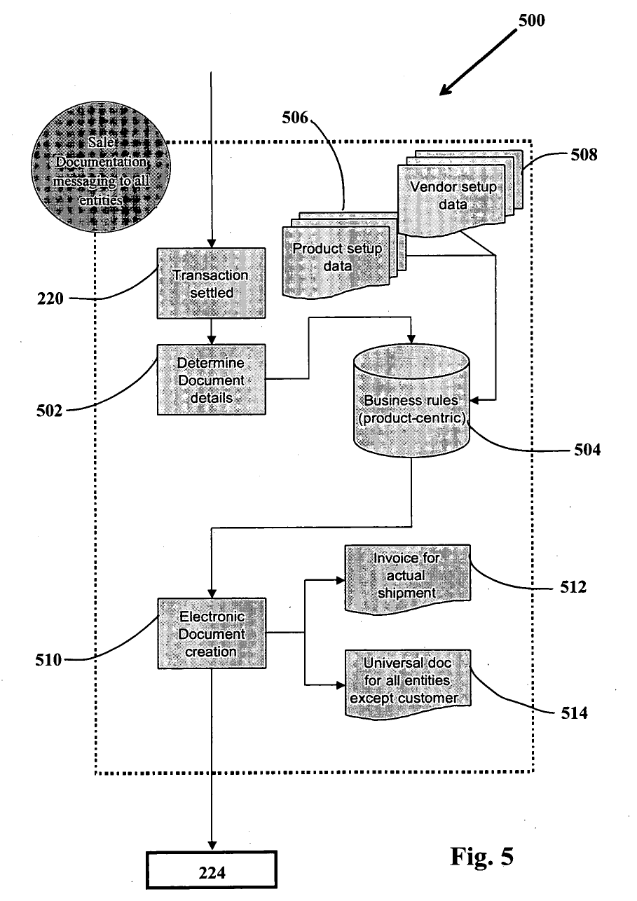

To comply with the applicable laws and regulations governing the states' “three tier” legal distribution channel 100 or with laws and regulations governing another multi-tier legal distribution channel, the compliance system 200 may as examples include (i) a license verification function; (ii) a funds disbursement messaging function; and/or (iii) a documentation function. A detailed description of these functions is found below and is illustrated in FIG. 3, FIG. 4 and FIG. 5, respectively.

A. License Verification

FIG. 3 is a flow diagram illustrating one example of one implementation of a license verification function 300 of the compliance system 200. The license verification function 300 may, as an example, execute step 208 of the compliance system 200 shown in FIG. 2. As illustrated in FIG. 3, the compliance system 200 may be designed to require a retailer 110 to enter their alcoholic beverages license number before placing a wine order. An input module may, as an implementation, be utilized at 206 for entry of licensing data, including such license number. An alcoholic beverages license number is generally required by law to purchase alcohol for resale. Upon the receipt of a trade customer alcoholic beverages license number, the license verification function 300 of the compliance system 200 may verify the validity of the license number entered into the compliance system 200. By requiring this verification, the license verification function 300 may ensure that only orders placed by validly licensed trade customer may be processed. Further, the license verification function 300 of the compliance system 200 may restrict the shipment of any order to the address held on file with the licensing authorities governing the sale of alcohol to the trade customer.

The license verification function 300 may, as an example, be implemented on a winery's website. The license verification function 300 may begin at 302, where a business-to-business (“B2B”) trade customer, such as a retailer 110, may initiate a process to gain access to wine ordering through the compliance system 200 by entering a license number and the state in which the retailer 110 resides. Such license verification may be performed, for example, during customer account setup on a winery website. At 304, the license number and state combination may be used to verify the license against a database of official licensing data. This database may contain all licensing data available from the designated state, and may then determine whether the license is valid. As an example, the data may include wine resale licensing data. In further implementations, the data may relate to other alcoholic beverages or to other regulated products. The database may be updated at 306 by collecting feeds of data from each state authority in charge of controlling licenses. This database may be periodically updated in accordance with a schedule when each state makes their records available. This database updating at 306 may be a manual collection process or may be automated via an electronic feed.

At 308, the licensed status of the B2B trade customer, such as a retailer 110, may be verified. If the license is found to be invalid, then the trade customer may be designated as an unverified trade customer at 310. A manual verification process may then be executed at 312. If a valid license is found at 312, then the licensing database at 304 may be accordingly updated. Once the B2B customer's license has been verified at 314, the customer may then be designated as a verified customer at 314. Further, a “SHIP TO” field for the customer's wine order may be pre-filled with address details associated with that “LICENSE” number and “STATE” combination. The trade customer may then be enabled to edit “BILL TO” order details but the “SHIP TO” field may be locked to be as per the “LICENSE” information obtained at 304.

At 316, previously verified trade customers may be enabled to login to the compliance system 200. Trade customer licenses may be checked each time updates are made at 306 to the licensing database accessed at 304. Licenses may also be checked once an order is placed, by using a manual check with the relevant state licensing agency or other governing authority. As an implementation, a processing module may be utilized to carry out some or all portions of the license verification function 300. Alternatively, the license verification process may be entirely performed manually, either upon registration with the winery's website or, as suggested above, upon order placement, prior to processing and fulfillment.

B. Funds Disbursement Messaging

FIG. 4 is a flow diagram illustrating one example of one implementation of a sale funds disbursement messaging function 400 of the compliance system 200. The funds disbursement messaging function 400 may, as an example, execute step 224 of the compliance system 200 shown in FIG. 2. Once an order is requested, payment may be made on-line by the trade customer online via a credit card, debit card, or cash equivalent where applicable. Then, as illustrated by FIG. 4, once the order has been shipped, the settled funds may be placed into a third party financial account from which disbursements may be made to each of the legal parties involved in the transaction. Thus, the funds disbursement messaging function 400 of the compliance system 200 may facilitate the task of issuing payment to each of the legal entities involved in the transaction and instruct the appropriate parties to remit any taxes or other funds to any third parties as required by law.

The funds disbursement messaging function 400 may, as an example, be implemented on a winery's website as illustrated in FIG. 4. Prior to utilization of the funds disbursement messaging function 400 by the compliance system 200, the transaction may pass through steps 202-222 (See FIG. 2). The transaction may function just like a regular online sale, with payment accepted via credit card, debit card or cash equivalent at 212, until the point at which the product is ready to ship at 218 and the funds are settled at 220. The trade customer, such as a retailer 110, may control whether the product is ready to ship or not at 218 by directly interfacing with the compliance system 200. As further explained below, the trade customer may acknowledge the order and prepare it for shipment, or may designate a fulfillment service to do so on their behalf. The notification at 220 that the product is shipping could be via an electronic messaging or a more manual system such as verbally communicating that this stage has been reached. Once the funds are settled at 220 and messaging regarding sale documentation has been generated at 222, the compliance system 200 may enter the funds disbursement messaging function 400.

Referring to FIG. 4, the funds may first be deposited into a third party financial account 402 and disbursement details may be determined 404. The third party financial account 402 may then be “messaged” 410 with instruction details to distribute funds based on the nature of the original order. This messaging, at 410, may be an electronic or a manual process. Each order may be for a wine product. Accordingly, the funds disbursement messaging function 400 of the compliance system 200 may, at 406, apply product-centric business rules to facilitate the funds messaging distribution. Product setup data may be referenced 408 to generate the business rules. As an example, the product setup data may include a database of regulated products for resale. The manner in which these business rules are referenced at 408 may be electronic or manual. At 412, messaging regarding funds to be disbursed may be sent to the legal parties involved in the transaction, including as examples, a producer 104, an out-of-state-shipper 116, and a wholesaler 106. As examples, these messages regarding funds disbursements may be made electronically or may be handled manually. There are many ways in which such messaging regarding funds disbursements may be sent. The messaging for funds disbursements may even be issued periodically rather than for every order placed on the compliance system 200.

C. Documentation

FIG. 5 is a flow diagram illustrating one example of one implementation of a documentation function 500 of the compliance system 200. The documentation function 500 may, as an example, execute step 222 of the compliance system 200 shown in FIG. 2. The funds disbursement messaging function 400 and the documentation function 500, collectively indicated by box 228 of FIG. 2, may both help to ensure that a sale of regulated products is compliant with state laws. In tandem with the sales funds disbursement messaging function 400, facilitating the distribution of funds to all of the entities involved, the documentation function 500 of the compliance system 200 may issue supporting documentation to chart the successful order, sale and delivery of the regulated products. For example, the documentation function 500 of the compliance system 200 may create new documentation for each transaction. Such transaction-specific documentation may provide the three tier legal distribution channel with an efficient solution to the dilemma of handling smaller orders by performing a disbursement messaging function resulting in an invoice role.

The documentation messaging function 500 may, as an example, be implemented on a winery's website. Referring to FIG. 5, the transaction or funds may be settled, as illustrated at 220, also shown in FIG. 2. The successful settlement may then trigger the creation of documentation to support the sale. These documents may be issued to all parties involved in the transaction and held as a record. At 502, details of required documents may be determined. All licensing data, taxes paid and other legal requirements can be detailed in this documentation. At 504, the document function 500 of the compliance system 200 may apply product-centric business rules to control the document preparation. Product setup data may be referenced 506 and vendor setup data may be referenced 508 to generate the business rules applied, at 504. As an example, the product setup data 506 may include a database of regulated products for resale. The required documents may then be electronically created at 510. The creation of these documents may be dynamic within the compliance system 200 or may even be manual in some or all cases. Invoice documents for actual shipment to the transaction customer may be electronically created at 512. Universal transaction documents for all entities involved in a transaction, other than the trade customer, may be electronically generated at 514. The documents may be distributed electronically, via fax, mail or held in the compliance system 200 and referenced by those entities involved on-demand. Transaction histories may be viewed and reports may be generated from this information. Following completion of steps 502-514, the compliance system 200 may facilitate the messaging required to trigger sale funds disbursement messaging 224, as discussed in Section 1.B above.

Although FIGS. 2 & 5 describe the creation of the documentation just before, after or simultaneously with the distribution of funds, those skilled in the art will recognize that documentation may be created for all or a portion of the entities at various time in the transaction process, as necessary to comply with law of various jurisdictions. For example, documentation may be forwarded to the wholesaler whose license is involved in the transaction for verification and/or approval of the sale by the wholesaler prior to order fulfillment.

2. Example System Implementation

A compliance system may take the form of a standalone software application, a website, or may take the form of a software module, a hardware component or any combination including one or more such applications, modules and/or components capable of performing the functions or processes described in this application. With respect to software, the compliance system may form all or part of a software program that may include one or more systems or programs. When the compliance system includes more than one system or program, the programs may be developed for the specific purpose of interfacing with one another or may be independently developed and linked together upon execution. Further, the compliance system may take the form of an upgrade to an existing program or application, such as an e-commerce program or order fulfillment application, or may be included as part of a new program or system. The compliance system may be implemented in the form of a website, on a personal computer, network computer, server, or any device capable of processing a software application, and may be accessible via the Internet, via an intranet, or other communications network.

As an example, the compliance system may be designed as a stand-alone software application for use by a producer 104 of regulated products such as a winery and/or by a wholesaler 106. In another implementation, the compliance system may be a program accessible by producers 104 such as wineries and/or by wholesalers 106 via the Internet. As a further example, the compliance system may be integrated into a producer's or a wholesaler's website for online order processing and fulfillment. While the compliance system is described at various points in this application as being designed for use by wineries, those skilled in the art will recognize that other producers 104 of regulated products, and wholesalers 106 of regulated products, may utilize such a compliance system or certain features provided by the system. It is further understood that retailers 110 may utilize a compliance system as customers of wholesalers 106 and/or producers 104. Further, wholesalers 106 and end customer may also utilize the compliance system.

In one example, a compliance system may be described in terms of the following five processes: (A) Wholesale Product & Customer Setup; (B) Wholesale Customer Verification Process; (C) Pricing, Availability and Limitations; (D) Gateway/Transactions; and (E) Reporting Including Sales Documentation. Any of these processes may be handled through an automated system or by way of categorizing and manually managing the process. Example operations and functions that may be performed by each process are described below.

A. Wholesale Product & Customer Setup

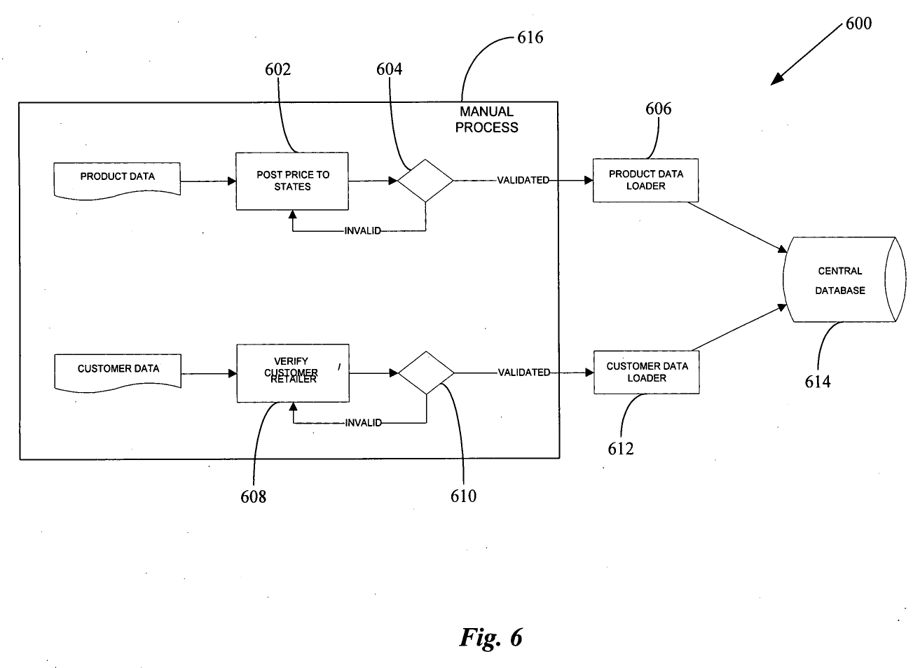

As an initial matter, the compliance system, if providing order fulfillment, may be enabled to access customer data and product data to complete a transaction. FIG. 6 is a flow diagram illustrating one example of one implementation of a process 600 of loading customer data, such as retailer data, and regulated product data, into a central database as part of the compliance system. The process 600 may begin at 602 with the regulated product data being matched with applicable post prices for the regulated products from state regulatory authorities. In implementation, this match-up may include accessing a database of official post prices for regulated products. Product data that are successfully matched with post prices for particular states may be validated at 604 and then submitted to a product data loader at 606. The process 600 may alternatively or additionally begin with an input of customer data to a customer/retailer verification at 608. Customer data that are successfully verified at 608 may be validated at 610 and then submitted to a customer data loader at 612. As an example, validation and loading of regulated product data in process steps 602, 604 and 606, and validation and loading of customer data in process steps 608, 610 and 612, may each be carried out independently. At 614, the regulated product data and the customer data may be loaded into a central database. As an example, the central database may include a database of regulated products for resale. In implementation, validation of regulated product data and customer data may be carried out manually as indicated by the box 616, or may entirely or partially automated.

The central database 614 may interface with only one compliance system or may be capable of interfacing with more than one compliance system. For compliance purposes, data verification may, as an example, be required prior to populating the central database 614 with customer and/or regulated product information. Referring to FIG. 2, the regulated product validated data may be, as an example, utilized to place wine orders 212. Further, the customer validated data may be utilized to determine whether a customer is an existing customer 204, FIG. 2, or whether the customer has a valid license 226.

Customer/retailer 112 licenses may as an example be manually verified and validated at steps 608 and 610 through state Alcohol Beverage Control (“ABC”) boards. State ABC boards may be located, for example, through various websites, such as http://www.ttb.gov/alcohol/info/faq/subpages/lcb.htm. Regulated product pricing may be verified and validated at steps 602 and 604 by checking state product price postings. Regarding the state of New York, the New York Posted Price may be currently found at http://abc.state.ny.us/JSP/wholesale/WholesalePage.jsp. As to the state of Virginia, the Virginia Posted Price List Download may be currently located at, http://www.abc.state.va.us/Pricelist/data.html.

Information concerning the regulated products offered for sale by each compliance system may be stored by or accessible by the compliance system at 602. Regulated product information may be maintained by the compliance system, for example, in a Microsoft Excel spreadsheet, in a Microsoft Access file, or in any other electronic, paper, or other file for storing such information. State laws generally require the posting of certain regulated product information. Such required information for each regulated product may as an example be stored in product fields by the compliance system and posted as required. For each state, the following information at a minimum may be posted, as an example, for each regulated product: regulated product name; vintage; alcohol content; COLA ID; and price. The “COLA ID” is a unique 14 digit number assigned to each regulated product by the Alcohol and Tobacco Tax and Trade Bureau of the Unites States Department of the Treasury (“TTB”).

Some states, such as New York, require the posting of additional information. See the NYS “Schedule of Wine Prices to Retailers,” which may be currently located at http://abc.state.ny.us/wholesale/forms/winetoretailprice.pdf. New York and other states may require, as examples, the posting of the following regulated product information: brand label registration #; size; age; alcohol content; master price per bottle; master price per case; price change per bottle; price change per case; number of bottles per case; and discount for quantity. To comply with state information posting requirements, only price posted products that have been verified with state posted price lists may, as an example, be stored at 614 in the compliance system central database. Product information may be stored and/or loaded into appropriate product tables.

B. Wholesale Customer Verification Process

Referring to FIG. 2, a login process 210 for a trade customer such as a retailer 110 may include utilizing an e-mail address as a login id. The trade customer may be identified as a verified buyer utilizing customer data from the central database before being provided a view into the business-to-business (“B2B”) instance at the website. The compliance system 200 may then ensure that the retailer 110 is not able to change the “SHIP TO” address 212. As another example, the trade customer may not be subject to a compliance volume purchase limit as may currently be applied to business-to-consumer (“B2C”) sales of regulated products. Identification of a trade customer as being verified may be indicated by designating a B2B flag in an “on” mode in the customer data loaded into the central database 614.

C. Pricing, Availability & Limitations

In an example, a data table may be stored in the central database 614 for handling state pricing information. Each state may have different pricing and related information. As an implementation, such a data table may have data fields including: stock keeping unit (“sku”) id, allow backorder, amount in stock, discountable, global limit quantity, has global limit, compliance system owner product code, live flag, price, product id, sequence number, sku code, unique name, upc, weight, hard ship cost per unit, free ship with wine, per unit ship cost, B2B COLA number, and B2B price id. The B2B price id field may, as an example, have sub-data fields including state id and price. In a further implementation, the compliance system may allow for an accounting of required minimum purchasing quantities. As an example, a minimum purchase of six (6) bottles of any regulated products having the same stock keeping unit number may be required. In one example, such a minimum may be based on the quantity of units, and not on their size. As a further implementation, in any case where the state pricing information does not indicate a B2B COLA number for a given regulated product, then the compliance system may not load the product, step 606, into the central database at 614. In an additional example, a minimum price of at least $0.01 or some other minimum price may be required for the sale of each regulated product.

D. Gateway/Transactions

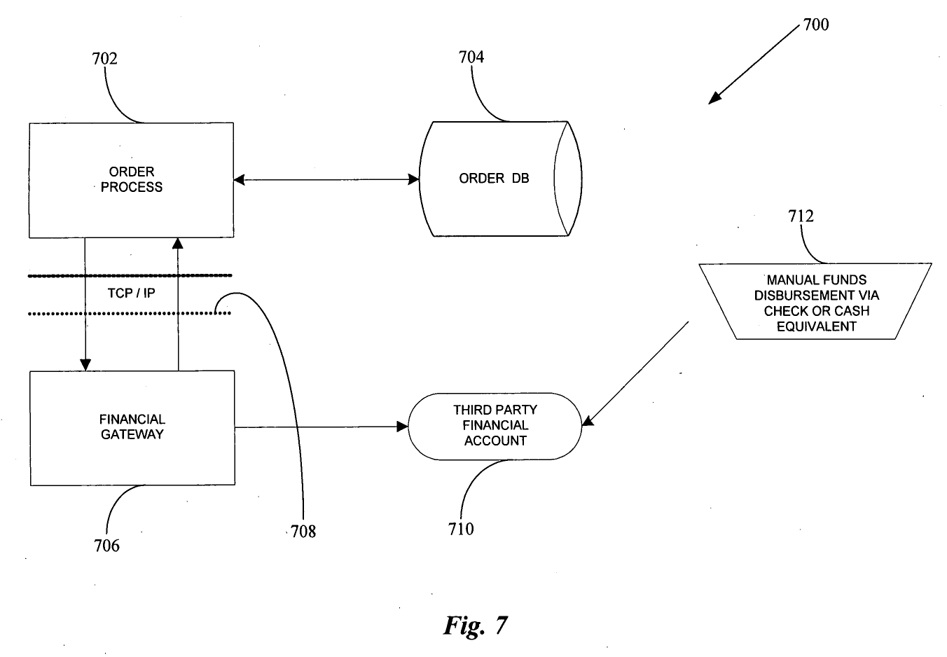

FIG. 7 is a flow diagram illustrating one example of one implementation of a system 700 for handling financial transactions as part of the compliance system. The system 700 may, as an example, include an order process 702. As an example, the order process 702 may be enabled to access an order database 704. In implementation, the order process 702 may interface with a financial gateway 706. The interface may be, for example, an Internet link such as a TCP/IP protocol interface 708. As an implementation, the financial gateway 706 may communicate with a third party financial account 710. The third party financial account 710 may, as an example, receive manual funds disbursements from the appropriate financial institution as facilitated by the compliance system. These disbursements may take the form of a check or cash equivalent from a source 712, and the checks may then be forwarded through the third party financial account 710 to the check endorsees.

When a retailer 110 pays for a regulated product, an order may be sent by the order process 702 to the third party financial account 710 via the financial gateway 706. The funds owed to parties involved in the sales transaction may then be manually dispersed from the third party financial account 710 based on pre-negotiated rates via check, wire transfer or cash equivalent as appropriate. As examples, such reimbursements may be payable to an out-of-state shipper 116, a wholesaler 106, a producer 104 such as a winery, and/or a compliance system owner discussed further below (not shown in FIG. 1).

The compliance system may, as an example, be designed to enable the compliance system owner/licensor (“compliance system owner”) to act as a broker for the retailer 110. In implementation, transactions controlled by the compliance system may be handled via the financial gateway 706. All funds may then be collected into a single third party financial account 710 managed by a financial organization. Negotiated funds may then be disbursed manually to the parties to which they are owed, such as a winery producer 104, a wholesaler 106, an out-of-state shipper 116, and/or the compliance system owner.

E. Reporting Including Sales Documentation

In another example of an implementation, the compliance system may be enabled to generate canned reports designed to meet various state documentation requirements for sales of regulated products. As an example, order processing reports may include retail license numbers and/or other information required by a governing state's licensing laws and regulations, to verify legal compliance. State-specific order reports, as an implementation, may also be generated to document the disbursement of funds to an out-of-state shipper 116 and/or to a wholesaler 106.

3. System Functionality

In general, the compliance system, when implemented as an online e-commerce system, may vary from typical end-user online ordering systems. Since the compliance system is designed to process business-to-business transactions, different considerations may be made in the system design from those in designing B2C systems. As an example, for confidentiality purposes, the compliance system may be designed to only provide pricing and regulated product availability to verified customers. Customer verification may be performed, as an example, by requiring entry of a valid regulated product resale license number associated with a given state as determined by an online check against official state records. License number and applicable state data may, for example, be gathered as part of customer registration for verification. The compliance system may also provide certain messages to trade customers, having formats that are in compliance with state posting requirements for pricing and regulated product information. Such state posting requirements may, as an example, include controlled access to changing the shipping address information.

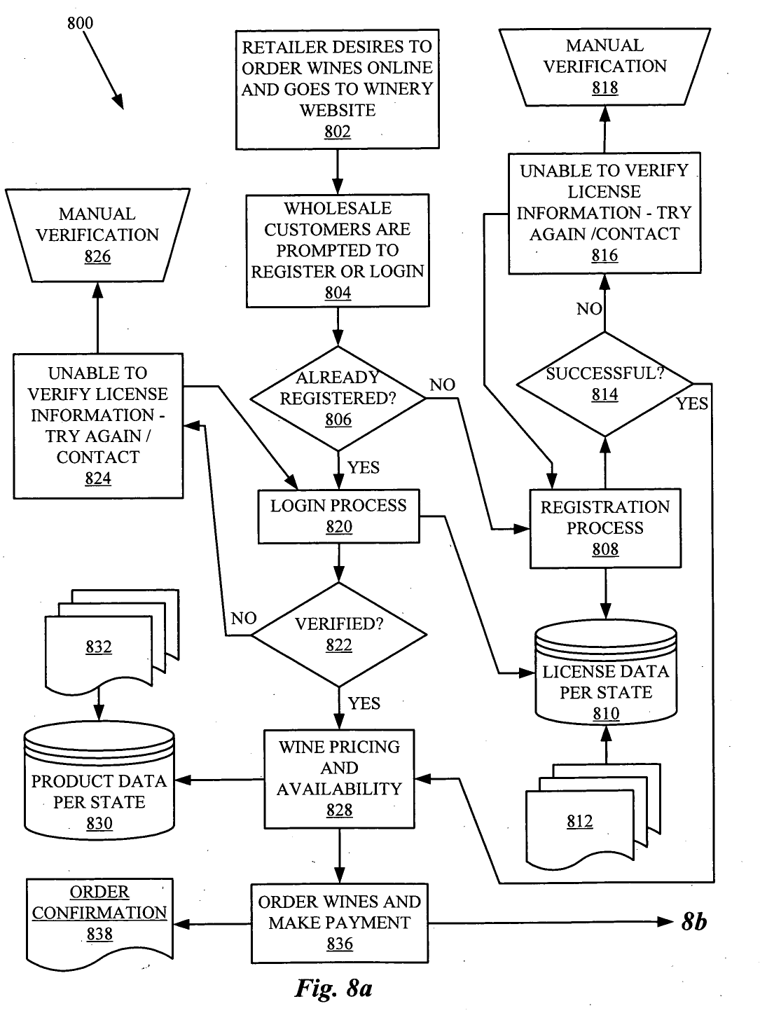

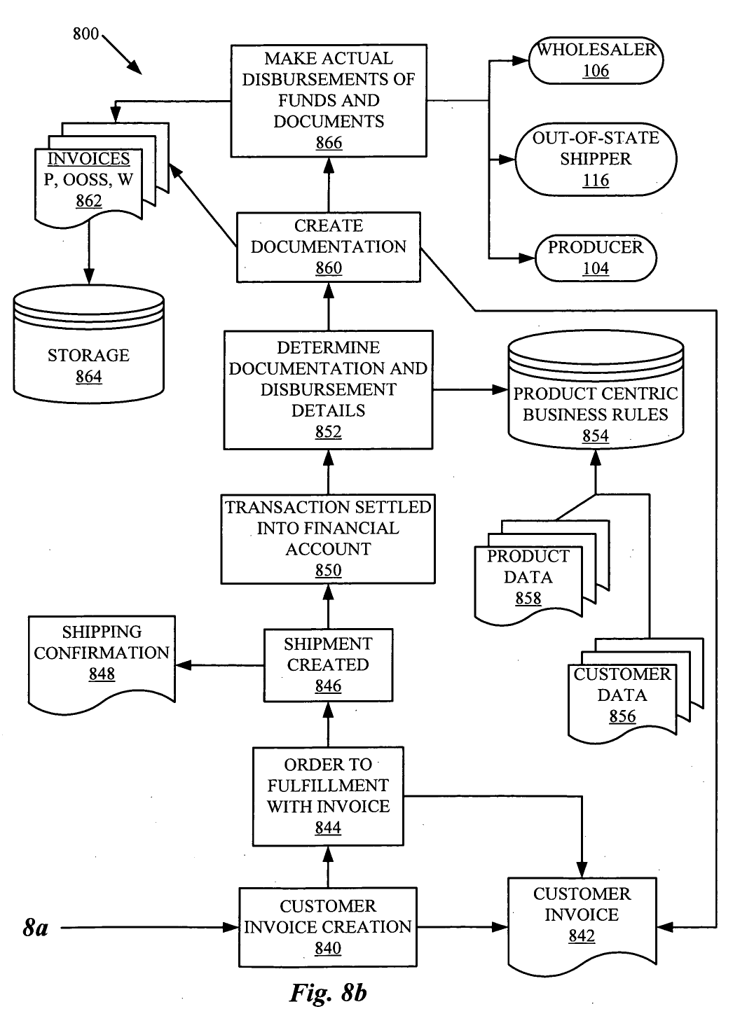

FIG. 8a is a flow diagram illustrating one example of one implementation of a compliance system 800 that may be capable of fulfilling a wholesale purchase order submitted by a retailer 110 via a regulated product producer 104. FIG. 8b is a continuation of the flow diagram of FIG. 8a. For example, the compliance system 800 may be activated at 802 when a retailer 110 desires to order wine and goes to the website of a winery producer 104. At 804, customers such as retailers 110 and wholesalers 106 may be prompted to register or login. This prompt may also occur at other points in operation of the compliance system 800. A decision point at 806 may indicate a “yes” or “no” decision as to whether a retailer 110 is already registered. If the retailer 110 is not already registered, then a registration process may be initiated at 808. During the registration process, official licensing data per state may be accessed at 810. As an example, the data may include wine resale licensing data. In further implementations, the data may relate to other alcoholic beverages or to other regulated products. Such data may be entered onto the official licensing data per state database at 812, which may be carried out as such data become available. A decision point at 814 may indicate a “yes” or “no” decision as to whether the registration process at 808 was successful. If not, then a notice to the retailer 110 may be displayed at 816 indicating that the compliance system 800 has been unable to verify the retailer's licensing data, and inviting the retailer to either try again to register or contact an appropriate person for assistance. As an example, manual verification may then be undertaken at 818. Licensing data may be entered by utilizing an input module, and a processing module may be utilized to access the official licensing data per state and to verify the retailer's licensing data.

Returning to the “already registered” decision point at 806, a “yes” indication may result in updating of the official licensing data per state database at 810, and may take the retailer 110 to a login process at 820. A decision point at 822 may indicate a “yes” or “no” decision as to whether the login at 820 was verified. If not, then a notice to the retailer 110 may be displayed at 824 indicating that the compliance system 800 has been unable to verify the retailer's login information, and inviting the retailer to either try again to login or contact an appropriate person for assistance. As an example, manual verification of the login may then be undertaken at 826.

Returning to the “login verified” decision point at 822, a “yes” indication there may take the retailer 110 to wine pricing and availability information at 828. As another example, if the registration process at 808 for the retailer 110 is found successful at 814, then the retailer may be taken directly to wine pricing and availability at 828. In implementation, the wholesaler 106 that facilitates the transaction may be listed as the seller together with the wine pricing and availability information, in compliance with non-solicitation regulations. As an example, the compliance system 800 may access an official product data per state database at 830 in connection with providing the wine pricing and availability information at 828. Such data may be entered onto the official product data per state database at 832, which data entry may be carried out as such data become available. As an example, the official product data per state database may include a database of regulated products for resale.

After reviewing the wine pricing and availability information 828, the retailer 110 may then order wines and make payment for them 836. This order and payment, at 836, may, for example, be similar to a typical B2C order and payment transaction. However, order fulfillment and confirmation may be different, as an example, with shipments restricted to the address indicated in the retailer's regulated product resale license 112. An order confirmation may then be provided to the retailer 110 at 838. FIG. 8a is continued in FIG. 8b, as indicated by the arrows so labeled. Thus, the remaining steps described below will be described with reference with FIG. 8b.

The compliance system may as an example then generate initial information at 840 for inclusion in a customer invoice prepared at 842. Further information may then be added to the customer invoice as the customer order may next be sent to order fulfillment at 844. As an example, a wholesaler 106 participating in the retailer's transaction may be identified on the customer invoice. In implementation, the wholesaler 106 may be identified in the order confirmation prepared at 838, and a copy of the order confirmation may be shipped with the order. A shipment may in implementation then be created at 846, and a shipping confirmation may be sent to the retailer 110 at 848.

In one example of an implementation, the retailer's transaction may then be settled into a third party financial account at 850. As an example, the third party financial account may be controlled by a compliance system owner or licensor (“compliance system owner”). At 852, documentation and disbursement details of the transaction may be determined. In implementation, determination of documentation and disbursement details at 852 may include accessing a product centric rules database at 854. Customer data may be input to the product centric rules database at 856 and product data may be input to the product centric rules database at 858. Such data may be entered onto the product centric business rules database at 854 as such data become available.

At 860, documentation of the transaction may be created. As examples, further information for inclusion in a customer invoice may be sent to the customer invoice preparation at 842 and invoices may be generated at 862. In implementation, initial invoices needed during operation of the compliance system 800 may be manually generated, such that the prices per state and each state's laws and regulations regarding wholesale customer details may be referenced when creating the actual invoice documents. As another example, a universal invoice document may be created for utilization as to all wholesale customers. Parties to the transaction including a producer 104, an out-of-state shipper 116, and/or a wholesaler 106 may receive invoice copies. At 864, invoicing data may be stored in a database.

In implementation, actual disbursements of funds and documents may be made at 866. As an example, initial funds disbursements needed during operation of the compliance system 800 may include manual generation of hand checks or ACH transfers; and initial document distributions may be done by email and included with funds disbursements to ensure that all parties have received the documentation required by each state's laws and regulations. In implementation, funds and documents may be sent to a wholesaler 106, an out-of-state shipper 116, and/or a producer 104.

The compliance system 800 may be implemented as an online application accessible through the use of many different screens, all of which may follow a basic commerce engine template. The functions and user interactions illustrated in the flow diagram of the compliance system 800 depicted by FIGS. 8a and 8b may as examples be provided by and/or facilitated through the various screens highlighted and described below. It is recognized by those skilled in the art that the look and layout of the many different screens may vary, without departing from the teachings of this application.

For purposes of illustration, the example screens for implementation of the compliance system 800 are referred to by canonical names. These names are underlined to indicate that a reference is being made to a screen of the compliance system 800. The canonical names include:
Wine Catalog
Login
Wholesale Registration
Wholesale wine catalog
Wholesale cart
Wholesale Checkout
Wholesale Order Verify
Wholesale order confirmation
Wholesale ‘your account’

A. Wine Catalog

The Wine Catalog may be a page that any end consumer or trade customer may access. The Wine Catalog may show the wines that are for sale on the website and that do not require a special B2B login for purchase. The page may, as an example, include a link that leads wholesale customers to the Wholesale Registration. Wholesale customers in this context are B2B customers, and may include retailers 110, wholesalers 106, and out-of-state shippers 116 as examples. A similar link for wholesale customers may be provided on the home page, for example, under a WELCOME message.

B. Login

The Login page for wholesale customers may be the same login page as that which any end consumer may access. Existing wholesale customers may as examples enter their email address and password to login to the system. Such existing wholesale customers may in implementation also have the capability to have their password emailed to their address should they forget it.

Once a wholesale customer has submitted their login information, the current status of the wholesale customer's license may for example be checked against the latest records on file for their licensing state. As an example, this verification may be performed each time when a wholesale customer logs into the compliance system 800 to ensure that the system checks the license against the most recent records from a licensing state.

If the compliance system 800 determines that a wholesale customer's license is valid, then a Wholesale Wine Catalog page may for example be loaded. From this page, wholesale products may be viewed.

If the compliance system 800 determines that a license is invalid, the system may as an implementation display an inquiry message to determine if the licensing data was improperly entered. As an example, an option to contact the administrators of the web site may also be given, so that a manual license check may begin. This portion of the compliance system 800 may also include, for example, an option for a wholesale customer to override the initial license verification process. In implementation, a wholesale customer may then be enabled to place an order via the web site, with a manual check on the licensing data then being performed before the wine is shipped.

C. Wholesale Registration

The Wholesale Registration page may, for example, act as the main gateway to the wines available to customers including retailers 110, wholesalers 106 and out-of-state shippers 116. The Wholesale Registration page may in implementation collect information from such wholesale customers that may help to determine their customer status and that may help them start their online wholesale shopping experience.

Existing wholesale customers may, for example, login at the Wholesale Registration page in the same manner as at the Login page. New wholesale customers may, for example, register at the Wholesale Registration page by completing a registration form. In implementation, this registration form may have the same data fields as in a typical customer registration, with the addition of STATE and LICENSE NUMBER fields. As examples, the STATE and LICENSE NUMBER data fields may be the first data fields that a new customer has to complete, and may be required data fields.

Unlike the case of end consumer purchases, where such customers may only be prompted to register once they have finished shopping and wish to checkout, the compliance system 800 may, as an example, require wholesale customers to register or login before any wholesale product or pricing is shown. Under this example model, only verified wholesale customers may be able to access the wholesale regulated product availability and pricing.

As an implementation, once a customer such as a retailer 110, a wholesaler 106, or an out-of-state shipper 116 has submitted their login information, the current status of their license may then be checked against the latest official records for their licensing state. This verification may for example be performed each time when a wholesale customer logs into the compliance system 800. This verification may ensure that the current validity of a wholesale customer's license is confirmed in accordance with the most recent state records, as required to lawfully purchase the regulated products. The license records may, for example, be periodically obtained from each licensing state authority. As an implementation, after a wholesale customer license has been verified as valid, then the Wholesale Wine Catalog page may be loaded by the compliance system 800.

In implementation, the compliance system 800 may be designed to collect other customer information upon registration, including, but not limited to, the customer's age and date of birth. The compliance system 800 may further provide, for example, an indication of the information that may be required to verify a license, and an explanation that the license verification is being required to verify the customer's entitlement to buy wine wholesale. This feature of the compliance system 800 may also exhibit due diligence on the part of the parties involved such as a winery producer 104 and may highlight the commitment of such parties to legal compliance.

The compliance system 800 may, as an example, confirm that a wholesale customer's license is valid before displaying the Wholesale Wine Catalog. The compliance system 800 may also require the wholesale customer to verify the shipping and business details on file for the given license number and to obtain customer verification of such details before proceeding. This verification process may be done by displaying the Wholesale Checkout page, which may, as an example, include the pre-filled shipping details to which the verified license may be restricted. In implementation, the wholesale customer may then be prompted to enter billing information as part of their registration.

D. Wholesale Wine Catalog

Registered and verified customers such as retailers 110, wholesalers 106 and out-of-state shippers 116 may in implementation access the Wholesale Wine Catalog page. The Wholesale Wine Catalog may for example show the wines that are available for wholesale purchase. As an implementation, only wines that have been activated for wholesale purchase may be shown. Activated wines may be, as an example, those that have been setup as wholesale regulated products in the state where a given wholesale customer is licensed. The activated wholesale regulated product setup may for example be a manual process. As an implementation, the manual process may carefully capture regulated product information on the granular level to ensure compliance with all applicable licensing laws and regulations.

In implementation, the identity of a wholesaler 106 having a second tier wholesaler license 108 for the state of any retailer 110 or out-of-state shipper 116 constituting a wholesale customer involved in the transaction, and the identity of the winery producer 104, may be listed at the top of the page. Underneath the information regarding the wholesaler 106 and producer 104, a brief synopsis of any minimum ordering requirement and a statement that volume discounts apply but that pricing is shown per bottle may as examples be provided to the wholesale customer. In implementation, a minimum ordering requirement may be six (6) bottles of a given regulated product.

As an example, regulated product information fields shown to wholesale customers may include, at a minimum: “PRODUCT NAME”, “VINTAGE”, “DESCRIPTION”, “BOTTLE SIZE”, “WHOLESALE PRICING A”, “WHOLESALE PRICING B”, “WHOLESALE PRICING C”, and “DETAILED WINE INFORMATION”. The wholesale pricing A, B and C fields may for example be placeholders for pricing of three different volume purchase thresholds. In another implementation, other information may also be provided to a wholesale customer, depending upon licensing state requirements. The wholesale customer may then, for example, select the regulated products that they want to purchase and add the products to their cart. When a wholesale customer chooses to add regulated products to the cart, the compliance system 800 may take the wholesale customer to the Wholesale Cart where quantities may be selected.

The wholesale cart may, as an example, calculate regulated product values in a number of different ways, such as per unit, per bottle, and/or per minimum purchase order quantities. Further, the compliance system 800 may in implementation be designed to allow the winery producer 104 to set its own discount volumes with corresponding pricing, and to calculate volume discounts based upon rules dictated by the winery.

E. Wholesale Cart

In implementation, the Wholesale Cart page may allow wholesale customers to select purchase quantities for the wine(s) that they have added to their cart. As an example, the identity of a wholesaler 106 having a second tier wholesaler license 108 for the state of any retailer 110 or out-of-state shipper 116 constituting a wholesale customer involved in the transaction, and the identity of the winery producer 104, may be listed at the top of the page. In implementation, regulated product ordering rules may be provided on this page. As examples, ordering rules may include minimum purchase order requirements, volume discount information and applicability to the displayed pricing information, and different pricing schemes.

In a further implementation, regulated product information may also be provided to the wholesale customer for those items in the wholesale customer's cart. As examples, the displayed regulated product information may include the following information fields: “PRODUCT NAME”, “VINTAGE”, “BOTTLE SIZE”, “WHOLESALE PRICING A”, “WHOLESALE PRICING B”, “WHOLESALE PRICING C”, “QUANTITY”, and “PRICE”. The “PRICE” field may, for example, reflect combinations of “QUANTITY” and a “WHOLESALE PRICING” level A, B or C. The compliance system 800 may also enable wholesale customers to modify previously entered product purchase quantities.

F. Wholesale Checkout

In an example, a Wholesale Checkout page may be provided to a first time wholesale customer when they elect to checkout. As an implementation, billing information may be required from the customer. Shipping information may be pre-filled from the customer's official licensing data as per the state records, and may be blocked from being changed. In another implementation, “NAME”, “LICENSE NUMBER” and “PHONE” fields may also be displayed and may be populated with information gathered when the wholesale customer completes the Wholesale Registration page. The wholesale customer may also be allowed to modify certain fields. For example, email preferences may be listed and open to modification by the wholesale customer. A short statement at the top of the web page may, as an implementation, provide instructions for the page and make clear to the wholesale customer which field must be completed next to proceed.

Further, the compliance system 800 may, as an example, be designed to allow a wholesale customer to override pre-filled shipping information in the event that their license number is linked to old or inaccurate address information. In this instance for example, the compliance system may place a hold on the transaction pending manual verification through the applicable state licensing authority that the shipment information provided by the wholesale customer is validly associated with the customer's license number.

G. Wholesale Order Verify

In implementation, the identity of a wholesaler 106 having a second tier wholesaler license 108 for the state of any retailer 110 or out-of-state shipper 116 constituting a wholesale customer involved in a transaction, and the identity of the winery producer 104, may be listed at the top of the Wholesale Order Verify page. This page may, as an example, be displayed after an existing wholesale customer has chosen to check out from the Wholesale Cart or after a new wholesale customer has completed the Wholesale Checkout page. The Wholesale Order Verify page may as an implementation provide an opportunity to review the order details and confirm the wholesale customer's decision to place the order.

The Wholesale Order Verify page may as examples display customer information, shipping information, customer license number, and billing information. The compliance system 800 may, as an example, provide the wholesale customer with the ability to edit qualifying information, subject to compliance with applicable laws and regulations.

Additionally, the Wholesale Order Verify page may display the details of the actual order, including, but not limited to, regulated products ordered, product size, unit price, quantity and total value. Unit price information may be provided as a link to, or displayed along with, the listed quantity. Other information may also be included as selected or necessary to assist the wholesale customer with deciding to place the order. In another implementation, a shipping statement may be included at the foot of the page, to make clear aspects of the shipping arrangements such as approximate time, email confirmation, etc.

H. Wholesale Order Confirmation

Wholesale customers may be taken to the Wholesale Order Confirmation page once they have confirmed and placed their order on the Wholesale Order Verify page. In implementation, the identity of a wholesaler 106 having a second tier wholesaler license 108 for the state of any retailer 110 or out-of-state shipper 116 constituting a wholesale customer involved in a transaction, and the identity of the winery producer 104, may be listed at the top of the Wholesale Order Confirmation page.

The Wholesale Order Confirmation page may present details of the final order to the wholesale customer. As examples, customer information, billing information, shipping information and billing address information may be listed, as well as a listing of the regulated products in the order. These details and the actual order may, as an implementation, be listed as per the Wholesale Order Verify page. If the shipping method is standardized for wholesale purchases, then that method may, as an example, be omitted from the Wholesale Order Confirmation page.

The wholesale order confirmation may for example serve as an invoice until the actual shipment is delivered. Contact information guidelines to help guide the wholesale customer in the event of an issue with the order or its delivery may be provided with the wholesale order confirmation. For example, if the shipment never arrives, the wholesale order confirmation may include guidelines instructing the wholesale customer where to call for follow-up. Such contact information guidelines may, as an example, apply to all wholesale transactions. In implementation, the wholesale order confirmation may also be utilized to inform other parties to the transaction such as a wholesaler 106, a producer 104, and/or the out-of-state shipper 116 that the order has been placed.

I. Wholesale ‘Your Account’

In implementation, a Wholesale ‘Your Account’ page may allow a registered wholesale customer to update their personal profile and/or registration information. The compliance system 800 at a web site may for example include links to ‘YOUR ACCOUNT’ that may direct the wholesale customer to the Wholesale ‘Your Account’ page. The Wholesale ‘Your Account’ page may allow the wholesale customer access to the following data fields, for example: Change Password, Set Email Preferences, Review Past Orders/Check Order Status, Logout, Edit Personal Information, and/or Change Credit Card Information.

A customer-defined shipping destination may prevent a winery producer 104 from verifying that the producer is shipping the regulated products to a licensed wholesale customer. As an implementation, the wholesale customer accordingly may not be given the ability to modify shipping information. In another example, shipping details may not even be provided with the customer's account information. As a further implementation, the wholesale customer may be blocked from modifying the shipping details.

4. Example Operation

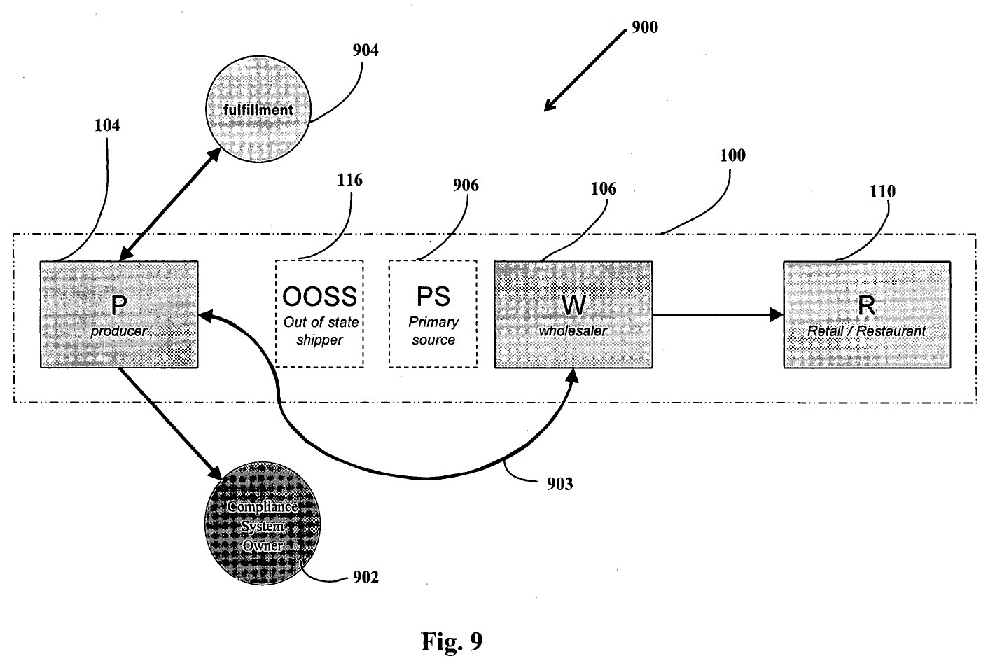

FIGS. 9-14 illustrate the operation of an example of one implementation of a compliance system.

A. Initiation

FIG. 9 illustrates one example of one implementation of an initiation process that may be utilized to implement a compliance system 900. As illustrated, the wine producer 104 may, as an example, be required to obtain a license from a compliance system owner or licensor (“compliance system owner” 902 to use the compliance system 900. A services agreement may be concluded between the producer 104 and the compliance system owner 902. The producer 104 may be required in an implementation to give regulated product pricing and label registration information and any other necessary paperwork to an OOSS 116 and to a wholesaler 106 to register the producer's regulated products for sale within the legal distribution channel 100 in markets selected by the producer. As an example, the OOSS 116 or wholesaler 106 may charge a fee for product label registrations. Capturing information at a product level may help make price posting and label registration quick and efficient. The producer 104 and the wholesaler 106 may for example conclude a distribution agreement indicated by the arrow 903. As an example, the distribution agreement may define a distribution relationship that is non-binding to the producer 104 so that the producer may easily make future changes in the distribution arrangements. The producer may also, for example, specify that orders are required to be routed to a fulfillment company 904 pursuant to a shipping agreement detailing the services to be performed and their costs. As a further implementation, an entity, often the producer 104, may be indicated as the “primary source” 906 of these regulated products, from which all wholesalers 106 and out-of-state shippers 116 may be required to directly purchase such products, as may be required by a state's laws or regulations.

B. Order Flow

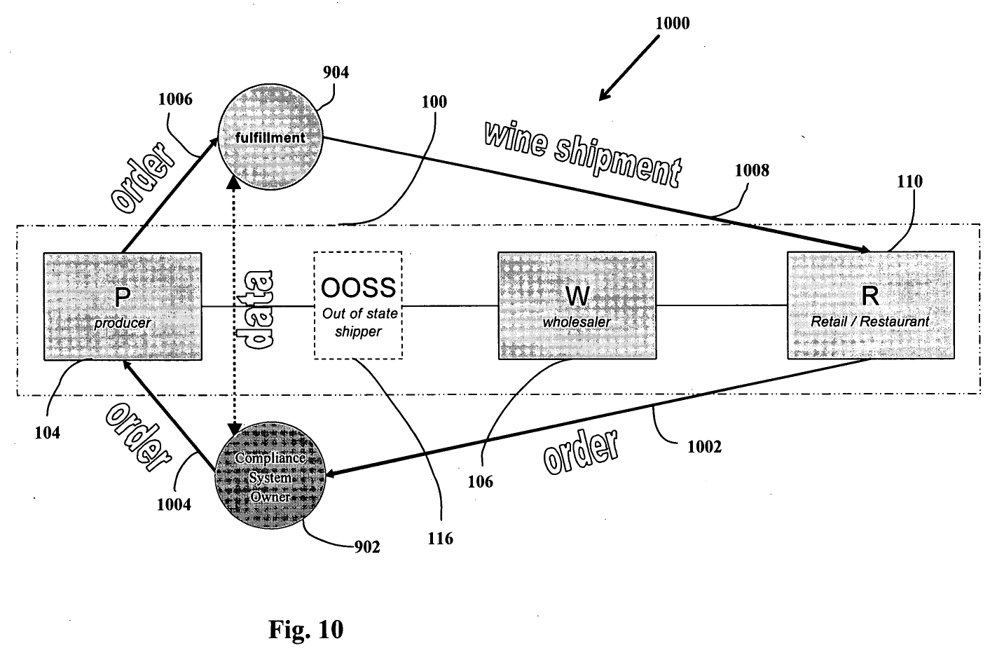

FIG. 10 illustrates one example of one implementation of an order flow 1000 during operation of the compliance system. As illustrated, a retailer 110 may, as an example, order regulated products directly from a winery producer 104 such that the order may be received by the compliance system owner 902 and then by the producer 104, as respectively indicated by the arrows 1002 and 1004. The retailer's order may then be forwarded to fulfillment 904 as indicated by the arrow 1006. The order may then be shipped by fulfillment 904 to the retailer 110 as indicated by the arrow 1008. Data may, in implementation, be exchanged between the compliance system owner 902 and fulfillment 904. As an example, fulfillment 904 may provide regulated product sales fulfillment data to the compliance system owner 902. The shipment may, as an example, be validated through the legal distribution channel 100 accessed via the wholesaler's license 108 and the retailer's license 112 to resell alcoholic beverages in the applicable state subject to that state's regulated product transaction documentation process. Supporting paperwork may be prepared that reflects the retailer's purchase of the regulated products from the wholesaler 106. An out-of-state shipper 116 may, as another implementation, be involved in the transaction.

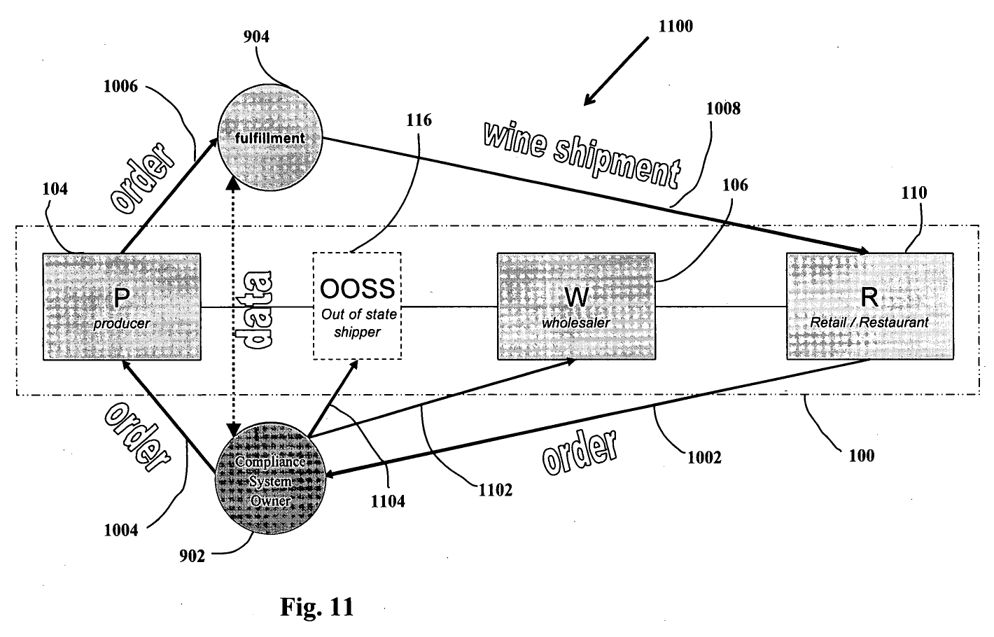

FIG. 11 illustrates another example of an implementation of an order flow 1100 during operation of the compliance system where a wholesaler 106 and optionally an OOSS 116 may be notified of the order prior to its completion. As an example, either or both the wholesaler 106 and/or the OOSS 116 may be notified of the order when it is placed, as respectively indicated by the arrows 1102 and 1104. In this manner, the wholesaler 106 and/or the OOSS 116 may be able to review, modify, accept or reject the order before it is shipped.

C. Transaction Detail

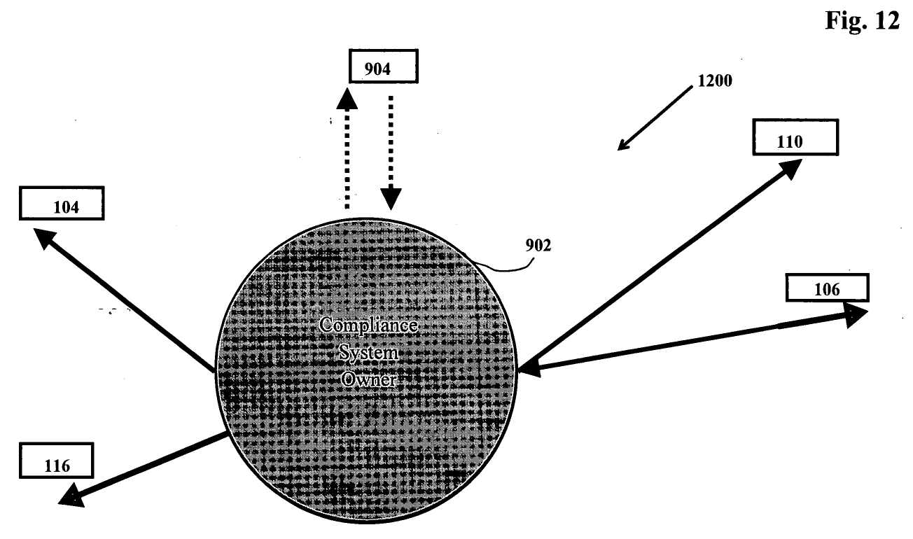

FIG. 12 illustrates one example of one implementation of a transaction detail function 1200 during operation of the compliance system. The compliance system may, as an example, verify a wholesale customer's license number and then populate a shipping information field with the address on STATE ABC file. As an implementation, the compliance system may only allow regulated products to ship to the address on file. These shipping related steps may be carried out by the compliance system owner 902. Product pricing may be dependant upon STATE and QUANTITY by reference to an applicable pricing matrix. A wholesaler 106 may be listed on an order page, as they are the actual seller of the regulated products. The compliance system may also provide for purchase limitations and/or product allocations to wholesale customers. Once an order is final and the purchase approved, a credit card transaction may be caused to occur. The purchase may then be confirmed to the wholesale customer and possibly to the other parties involved. Fulfillment information may be provided by interaction between the compliance system owner with a fulfillment service 904 or with the producer 104 themselves. As an example, fulfillment 904 may provide regulated product sales fulfillment data to the compliance system owner 902. As an example, the compliance system owner 902 may send order details to the fulfillment service 904, and the fulfillment service 904 may send shipment details to the compliance system owner 902. A “ready to ship” status including a tracking number, as an example, may trigger electronic creation and issuance of documents for the winery producer 104, the OOSS 116, the wholesaler 106, and the retailer 110. The transaction may be settled and the funds may be held in a third party financial account messaged by the compliance system owner. Funds may then be disbursed to the parties to the transaction per business rules via a check or an electronic transfer, either per transaction or periodically on a cumulative basis.

D. Funds Disbursement Messaging

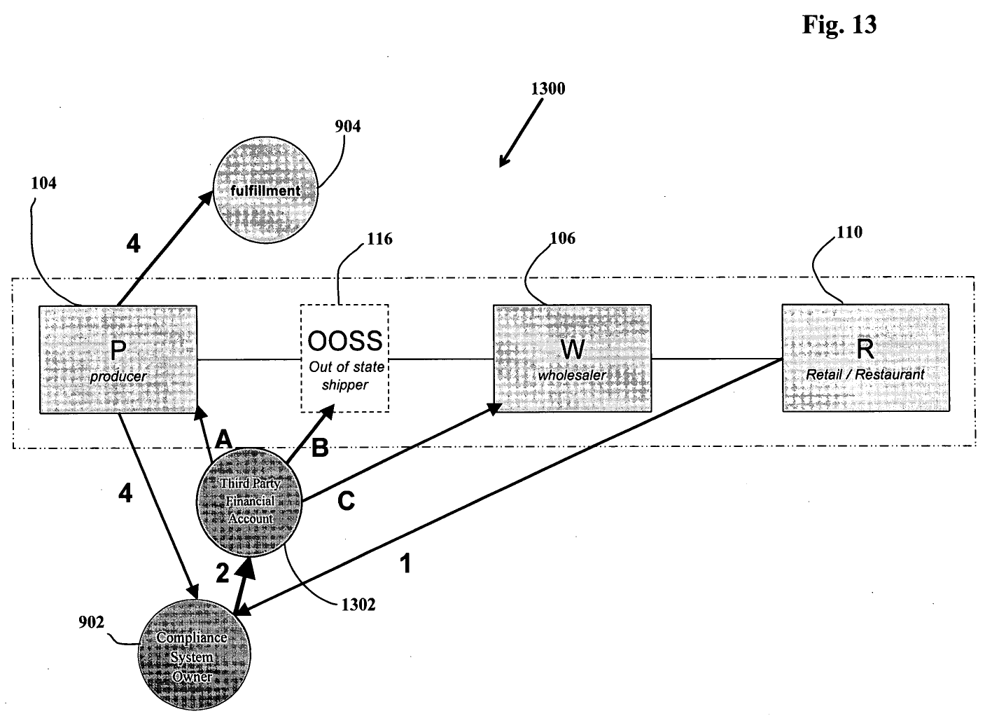

FIG. 13 illustrates one example of one implementation of a funds disbursement messaging function 1300 during the operation of the compliance system. In an example, the retailer 110 may (1) pay for wine on the website of a producer 104 as part of the order process. The compliance system owner 902 may (2) act as a “buyer's agent” to facilitate the sale in states where applicable. The purchase may in implementation be processed online via a gateway to the third party financial account 1302 messaged by the compliance system owner/licensor 902. After finalization of the transaction, the funds may be distributed as follows on a per transaction basis or periodically: (A) Producer's payment; (B) OOSS fee, and excise tax if applicable; and (C) Wholesaler fee, and excise tax if applicable. The producer 104 may (4) be required to pay for fulfillment 904, and for license fees to the compliance system owner 902 for use of the compliance system.

E. Documentation

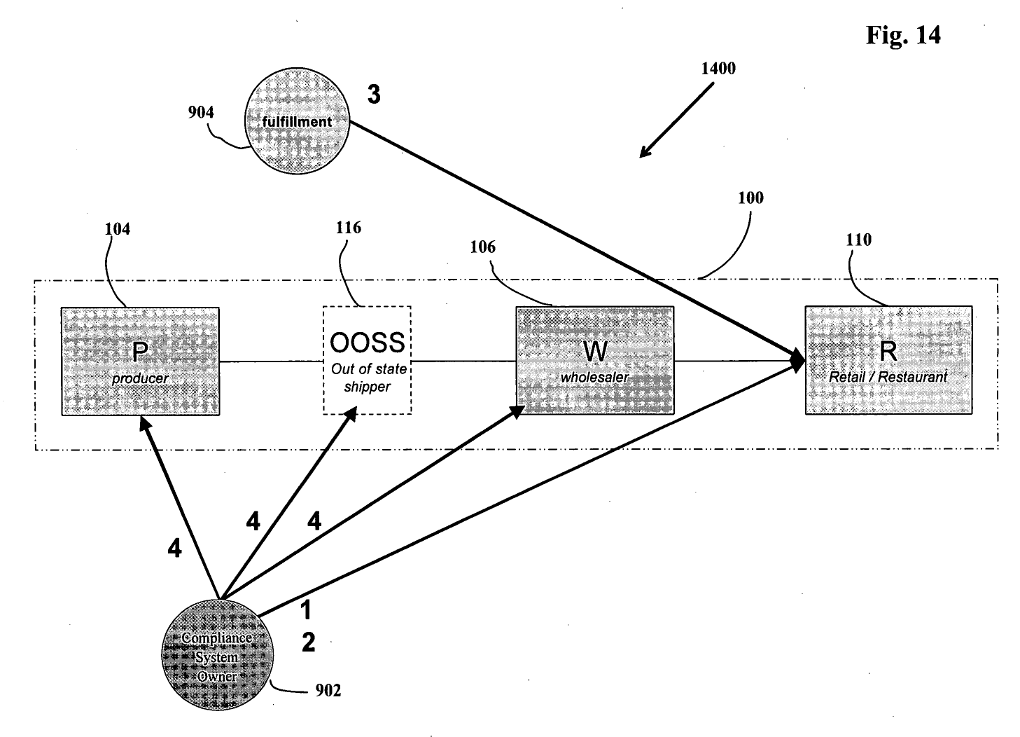

FIG. 14 illustrates one example of one implementation of a documentation preparation function 1400 during the operation of the compliance system. As an example, a compliance system owner 902 may be placed in control over transmission of regulated product sales transaction data to other entities involved in the transaction. The retailer 110 may (1) receive an order confirmation from the compliance system owner 902 as part of an online ordering process, in a manner similar to that typically done in a B2C transaction. The retailer 110 then may (2) receive shipment confirmation from the compliance system owner 902 as part of a fulfillment process, also in a manner similar to that typically done in a B2C transaction. The shipment may (3) be accompanied by an invoice showing the purchase by the retailer 110 from the wholesaler 106, and the price paid by the retailer may be shown. Fees paid to the three tiers of the legal compliance channel 100 including the producer 104, out-of-state shipper 116 and wholesaler 106 may, as an example, not be shown to the retailer 110. In implementation, a universal document may be produced by the compliance system owner 902 and sent (4) to the producer 104, wholesaler 106, and/or out-of-state shipper 116, documenting the sale of regulated products from the producer to the wholesaler via the OOSS if applicable, and detailing all licensees involved, including taxes paid. As an implementation, different details may be documented to different recipients as appropriate.

Persons skilled in the art will understand and appreciate, that one or more processes, sub-processes, or process steps described in connection with the compliance system and as illustrated in the attached figures may be performed by hardware and/or software. As examples, the hardware may include one or more input modules and one or more processing modules. Additionally, the compliance system may be implemented completely in software that Would be executed within a processing module or plurality of processing modules in a networked environment. Examples of processing modules include but are not limited to microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions (i.e., “logic” that may be implemented either in digital form such as digital circuitry or source code or optical circuitry or chemical or biochemical in analog form such as analog circuitry or an analog source such an analog electrical, sound or video signal), and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (herein known as a “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer (i.e., machine) data signals embodied in the carrier wave signal. The computer/machine data signals may include data or software that is transported or interacts with the carrier wave signal.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. In addition to the system features described in this document, those skilled in the art will recognize that other features may be included or offered in connection with the compliance system and should be viewed as within the scope of this invention. For example, the system may support any of the following features: allocations of products for customers; consolidation of orders from different producers; different shipping methods; control over shipping methods or information on shipping other than a tracking number; reporting tools other than those available under current B2C structure; funds disbursement calculations or actions; electronic document creation; compliance and setup data collection or preparation; free shipping promotions; and/or compliance related reporting of any specialized form. The claims and their equivalents define the scope of the invention.

What is claimed is:

1. A legal compliance system for facilitating the sale of regulated products and services, the system comprising:
an input module configured to receive licensing data including a shipping address; and
a processing module configured to access official licensing data, to determine from the official licensing data whether the received licensing data is valid, to obtain address information associated with the official licensing data, and to determine whether the obtained address information includes the shipping address associated with the received licensing data.

2. The legal compliance system of claim 1 where the received licensing data includes an associated licensing state.

3. The legal compliance system of claim 1 where the received licensing data includes an associated license number.

4. The legal compliance system of claim 1 where the received licensing data includes regulated product resale licensing data.

5. The legal compliance system of claim 1 where the input module is configured to receive wholesaler licensing data.

6. The legal compliance system of claim 1 where the input module is configured to receive retailer licensing data.

7. The legal compliance system of claim 1 where the input module is configured to receive out-of-state shipper licensing data.

8. The legal compliance system of claim 1 where the input module is configured to receive producer licensing data.

9. The legal compliance system of claim 1 where the input module is configured to receive alcoholic beverage resale licensing data.

10. The legal compliance system of claim 1 where the input module is configured to receive wine resale licensing data.

11. The legal compliance system of claim 1 further including a database of regulated products for resale.

12. The legal compliance system of claim 11 where the processing module is configured to block access to the database of regulated products for resale unless the processing module determines that the received licensing data is valid.

13. The legal compliance system of claim 1 where the processing module is configured to block a sale of regulated products unless the processing module determines that the received licensing data is valid.

14. The legal compliance system of claim 1 where the processing module is configured to block a change in the address information associated with the official licensing data.

15. The legal compliance system of claim 1 where the processing module is configured to generate messaging regarding documentation of a sale of regulated products.

16. The legal compliance system of claim 15 where the processing module is configured to access a database including product-centric business rules.

17. The legal compliance system of claim 16 where the database includes regulated product data and customer data associated with received licensing data.

18. The legal compliance system of claim 15 where the processing module is configured to protect wholesale pricing information from access by a regulated product consumer.

19. The legal compliance system of claim 1 where the processing module is configured to receive funds and to send messaging regarding disbursement of funds from a sale of regulated products.

20. The legal compliance system of claim 19 where the processing module is configured to access a database including product-centric business rules.

21. The legal compliance system of claim 1 where the input module is configured to receive regulated product data.

22. The legal compliance system of claim 21 where the processing module is configured to access a database of official post prices for regulated products, and to determine whether the received regulated product data is included in the database of official post prices.

23. The legal compliance system of claim 1 where the processing module is configured to place a compliance system owner in control over access by the processing module to official licensing data.

24. The legal compliance system of claim 1 where the processing module is configured to provide regulated product sales fulfillment data to a compliance system owner.

25. The legal compliance system of claim 1 where the processing module is configured to place a compliance system owner in control over transmission of regulated product sales transaction data to another entity involved in the transaction.

26. The legal compliance system of claim 1 where the processing module is configured to place a compliance system owner in receipt of funds from a regulated product sales transaction.

27. The legal compliance system of claim 26 where the processing module is configured to place the compliance system owner in control over messaging regarding disbursement of funds from a regulated product sales transaction.

28. A computer readable medium having a plurality of instructions for facilitating legal compliance in the sale of regulated products and services, the plurality of instructions comprising:
logic configured to receive licensing data including a shipping address;
logic configured to access official licensing data and to determine from the official licensing data whether the received licensing data is valid;
logic configured to obtain address information associated with the official licensing data; and
logic configured to determine whether the obtained address information includes the shipping address associated with the received licensing data.

29. The computer readable medium of claim 28 including logic configured to receive an identification of a licensing state associated with the received licensing data.

30. The computer readable medium of claim 28 including logic configured to receive an identification of a license number associated with the received licensing data.

31. The computer readable medium of claim 28 including logic configured to receive regulated product resale licensing data.

32. The computer readable medium of claim 28 including logic configured to receive wholesaler licensing data.

33. The computer readable medium of claim 28 including logic configured to receive retailer licensing data.

34. The computer readable medium of claim 28 including logic configured to receive out-of-state shipper licensing data.

35. The computer readable medium of claim 28 including logic configured to receive producer licensing data.

36. The computer readable medium of claim 28 including logic configured to receive alcoholic beverage resale licensing data.

37. The computer readable medium of claim 28 including logic configured to receive wine resale licensing data.

38. The computer readable medium of claim 28 including logic configured to access a database of regulated products for resale.

39. The computer readable medium of claim 38 including logic configured to block access to the database of regulated products for resale unless the received licensing data is valid.

40. The computer readable medium of claim 28 including logic configured to block a sale of regulated products unless the received licensing data is valid.

41. The computer readable medium of claim 28 including logic configured to block a change in the address information associated with the official licensing data.

42. The computer readable medium of claim 28 including logic configured to generate messaging regarding documentation of a sale of regulated products.

43. The computer readable medium of claim 42 including logic configured to access a database including product-centric business rules.

44. The computer readable medium of claim 43 including logic configured to access a database including regulated product data and customer data associated with received licensing data.

45. The computer readable medium of claim 28 including logic configured to protect wholesale pricing information from access by a regulated product consumer.

46. The computer readable medium of claim 28 including logic configured to receive funds and to send messaging regarding disbursement of funds from a sale of regulated products.

47. The computer readable medium of claim 46 including logic configured to access a database including product-centric business rules.

48. The computer readable medium of claim 28 including logic configured to receive regulated product data.

49. The computer readable medium of claim 28 including logic configured to access a database of official post prices for regulated products, and to determine whether the received regulated product data is included in the database of official post prices.

50. The computer readable medium of claim 28 including logic configured to place a compliance system owner in control over access by the processing module to official licensing data.

51. The computer readable medium of claim 28 including logic configured to provide regulated product sales fulfillment data to a compliance system owner.

52. The computer readable medium of claim 28 including logic configured to place a compliance system owner in control over transmission of regulated product sales transaction data to another entity involved in the transaction.

53. The computer readable medium of claim 28 including logic configured to place a compliance system owner in receipt of funds from a regulated product sales transaction.

54. The computer readable medium of claim 28 including logic configured to place the compliance system owner in control over messaging regarding disbursement of funds from a regulated product sales transaction.

55. A signal-bearing medium having software for facilitating legal compliance in the sale of regulated products and services, the signal-bearing medium comprising:
logic configured to obtain licensing data including a shipping address;
logic configured to obtain official licensing data;
logic configured to determine from the official licensing data whether the received licensing data is valid;
logic configured to obtain address information associated with the official licensing data; and
logic configured to determine whether the obtained address information includes the shipping address associated with the received licensing data.

56. The signal-bearing medium of claim 55 including logic configured to access a database of regulated products for resale.

57. The signal-bearing medium of claim 56 including logic configured to block access to the database of regulated products for resale unless the received licensing data is valid.

58. The signal-bearing medium of claim 55 including logic configured to block a sale of regulated products unless the received licensing data is valid.

59. The signal-bearing medium of claim 55 including logic configured to block a change in the address information associated with the official licensing data.

60. The signal-bearing medium of claim 55 including logic configured to generate documentation of a sale of regulated products.

61. The signal-bearing medium of claim 60 including logic configured to access a database including product-centric business rules.

62. The signal-bearing medium of claim 61 including logic configured to access a database that includes regulated product data and customer data associated with received licensing data.

63. The signal-bearing medium of claim 60 including logic configured to protect wholesale pricing information from access by a regulated product consumer.

64. The signal-bearing medium of claim 55 including logic configured to receive and to send messaging regarding disbursement of funds from a sale of regulated products.

65. The signal-bearing medium of claim 64 including logic configured to access a database including product-centric business rules.

66. The signal-bearing medium of claim 55 including logic configured to receive regulated product data.

67. The signal-bearing medium of claim 66 including logic configured to access a database of official post prices for regulated products, and to determine whether the received regulated product data is included in the database of official post prices.

68. The signal-bearing medium of claim 55 including logic configured to place a compliance system owner in control over access by the processing module to official licensing data.

69. The signal-bearing medium of claim 55 including logic configured to provide regulated product sales fulfillment data to a compliance system owner.

70. The signal-bearing medium of claim 55 including logic configured to place a compliance system owner in control over transmission of regulated product sales transaction data to another entity involved in the transaction.

71. The signal-bearing medium of claim 55 including logic configured to place a compliance system owner in receipt of funds from a regulated product sales transaction.

72. The signal-bearing medium of claim 71 including logic configured to place the compliance system owner in control over messaging regarding disbursement of funds from a regulated product sales transaction.

73. A legal compliance system for facilitating the sale of regulated products, the system comprising:
a database of official regulated products wholesaler licensing data; and
a processing module configured to receive trade customer licensing data, to validate the trade customer licensing data against official regulated products wholesaler licensing data, and to receive facilitate wholesaler approval of a sale of regulated products to a trade customer.

74. The legal compliance system of claim 73, in which the processing module is configured to facilitate a sale of regulated products from a regulated products producer to a retailer.

75. The legal compliance system of claim 73, in which the processing module is configured to facilitate the sale of regulated products in compliance with regulations governing trade of the products in a governing jurisdiction.

76. The legal compliance system of claim 73, in which the processing module is configured to coordinate a sale of regulated products from a seller holding a first type of license for reselling regulated products to a purchaser holding a second type of license for reselling regulated products.

77. The legal compliance system of claim 76, in which a wholesaler holds a third type of license for reselling regulated products.

78. The legal compliance system of claim 73 where the processing module is configured to generate messaging regarding documentation of a sale of regulated products.

79. The legal compliance system of claim 73 where the processing module is configured to receive funds and to send messaging regarding disbursement of funds from a sale of regulated products.

80. The legal compliance system of claim 73 where the processing module is configured to place the compliance system owner in control over messaging regarding disbursement of funds from a regulated product sales transaction.

81. The legal compliance system of claim 73, in which the processing module is configured to cause the database to be updated.

82. A legal compliance processing module, comprising:
means for integrally accessing official regulated products resale licensing data of resale licensees in a plurality of licensing jurisdictions; and
means for validating a resale licensee's regulated products resale licensing data against the official licensing data.

83. The legal compliance processing module of claim 82, including:
means for accessing address information associated with the official regulated products resale licensing data; and
means for validating a resale licensee's shipping address information against the address information associated with the official regulated products resale licensing data.
